(19) United States
(12) Patent Application Publication
(10) Pub. No.: US 2012/0055092 A1
(43) Pub. Date: Mar. 8, 2012

(54) SAFETY GATE

(76) Inventors: Sebastien Boucquey, Brussels (BE); Michel Bertsch, Gaaden (AT)

(21) Appl. No.: 13/219,139

(22) Filed: Aug. 26, 2011

Related U.S. Application Data
(63) Continuation of application No. PCT/EP2009/005790, filed on Aug. 10, 2009.

(30) Foreign Application Priority Data
Feb. 27, 2009 (DE) 10 2009 010 682.0

(51) Int. Cl. E06B 9/02; E05D 15/52; E05B 65/06

(52) U.S. Cl. 49/192; 49/386

(57) ABSTRACT

A safety gate, in particular for children, is provided that includes a stationarily positionable frame with a lower base and two side parts, the side parts extending upwards from the base, and a door member, the door member being articulated at the frame pivotably about a pivot axis. A closure member is arranged at one of two, the frame or the door member, and a countersupport is arranged at the respective other of the two, such that the closure member and the countersupport are interacting in a closed position of the door member. The door member can be moved in the direction of the pivot axis in order to release a positive blockade, wherein the movability of the door member in the direction of the pivot axis can be releasably locked via an actuable locking member.

This nonprovisional application is a continuation of International Application No. PCT/EP2009/005790, which was filed on Aug. 10, 2009, and which claims priority to German Patent Application No. DE 10 2009 010 682.0, which was filed in Germany on Feb. 27, 2009, and which are both herein incorporated by reference.

### BACKGROUND OF THE INVENTION

1. Field of the Invention

The invention relates to a safety gate, in particular for children, comprising a frame and a door member, the door member being articulated at the frame pivotably about a pivot axis.

2. Description of the Background Art

Safety gates are known in the prior art which can be inserted into door frames, passageways, staircases etc. in order to hinder small children, and eventually pets, from passing through. A closeable door is provided in the safety gate in order to allow for a simplest possible passage of an adult when the safety gate is installed.

### SUMMARY OF THE INVENTION

It is therefore an object of an embodiment of invention to provide a safety gate that can be operated by an adult in a simple way.

In an embodiment, the door member can be double secured, as for the opening firstly a locking member should be actuated in order to enable a subsequent moving or lifting of the door member in the direction of the pivot axis. Only by this movement, the door member can be released for its opening or pivoting about the pivot axis. Generally, the blockade, which is released by the lifting, can be provided at the location of the locking member, or being integrated with the locking member, or can be provided separated therefrom or can be provided at the locking member as well as separated therefrom.

In an embodiment of the invention, the locking member can be provided at the closure member, the locking member can have a spring loaded latch which can be moved in a linear direction. This allows for a simple, integrated construction of the double securing. In particular, the closure member may be formed ergonomically in the kind of a handle, such that for an adult, a comfortable operation of the locking member and lifting of the door member becomes possible even with a single hand.

Additionally or alternatively, a spring loaded catch can be provided at one of two, the closure member or the countersupport, the catch snapping into a latch of the locking member in the case of pivoting the door member into the closed position. In this way, the door member can lock automatically in the course of pivoting closed, in particular the latch of the locking member being separated from the function of the catch. This, inter alia, allows for a particularly strong design of a restoring spring of the latch, leading to an additional safety against an actuation by a small child. Yet, according to the demands, it may alternatively be provided that the spring loaded latch itself has the function of a catch and snaps into an countersupport when pivoting the door closed.

In an embodiment, an adjustable blocking member can be provided at the door member, wherein one of the pivot directions of the door member, starting from the closed position, can be releasably blocked by means of the blocking member. In this way an additional, selectable securing of the door member can be achieved. The blocking member can be arranged at the closure member, resulting in a simple, integrated construction. Further, with respect to a wide scope of function, no pivot direction, one of the two pivot directions or both pivot directions can be selectably blocked by the blocking member, the blocking member can have two displaceable blocking bars. The blocking member can also have a display for a visual control of a selected blocking function, such that an operator can identify the selected blocking function yet when approaching the safety gate.

In an embodiment of the invention, a further locking can be arranged at the door member, in particular for providing or supporting the positive blockade. Thereby, in particular a higher load resistance of the door member in the closed position can be achieved. For instance, the additional locking may be arranged in a lower area of the door, while the locking member and its countersupport, for the purpose of an easy operation, are arranged at an upper area of the door, such that the locking of the axial movability of the door member is achieved at one place and the locking against a pivoting of the door in a lowered position is achieved at a different place. Alternatively or additionally, a positive blockade may also be provided at the closure device itself.

In an embodiment, the further locking gets out of engagement by the movement of the door member in the direction of the pivot axis, hence a separate actuation for the additional locking being necessary. An automatic and particularly reliable locking of the further locking when pivoting the door closed can be achieved in that the further locking snaps shut by pivoting of the door member into the closed position, in particular by means of a spring loaded catch.

In an embodiment of the invention, it is provided that the pivot axis can be inclined with respect to a vertical, the pivot axis in particular extending in a plane with the frame and the closed door member. In this way it is achieved cost-effectively and reliably achieved that the door member, which is pivoted into an open position, pivots back into its closed position by means of gravitation. In order to provide for a restoring force which is sufficient, yet harmless for a small child, the inclination angle is between 1° and 5°, preferredly between 2° and 4°.

In the case of an alternative or additional embodiment of the invention it is provided that a swivel of the door member comprises an upper swivel half and a lower swivel half which are rotatable with respect to each other about the pivot axis, wherein the swivel halves are supported against each other by means of a sliding track which is progressing inclined with respect to the pivot axis, such that the swivel halves are continuously moving away from each other in the direction of the pivot axis with an increasing opening angle of the door member, in particular during deflection of a spring member, and wherein a force which is directed opposite to this movement causes a torque in a closing direction of the door member. Such swivel is particularly suitable for a combination with a door member according to the invention, as a movability of the swivel halves with respect to each other in the axial direction is already immanent in the design of the swivel.

In an embodiment, the sliding track can be formed at a first of the two swivel halves as a front side rim area of a hollow cylindrical section, wherein the hollow cylindrical section, starting from its rim area, is covered by a sleeve part of the other, second swivel half. This design prevents for a jamming of items or body parts in the region of the swivel halves and sliding tracks. Further advantageously, a radial, mutual support of the swivel halves can be achieved by a sliding contact of the hollow cylindrical section with an inside face of the sleeve part. Further to the advantage of the simple construction, a sufficient stability of the swivel is provided even in case of forming the swivel halves from a soft material like a polymer. In particular, a metal hinge pin for the purpose of supporting a radial force can be omitted.

In an embodiment, a sliding track of the second swivel half can be formed as a bottom area of said sleeve part and interacts with the sliding track of the first swivel half. Particularly advantageously, a tenon formed as one piece is protruding from the bottom plane, the tenon being penetrated by an anchorage, which in particular is made from metal. The anchorage thereby is not working as a hinge pin, as it is loaded mostly in axial direction, in particular by means of the spring member which is supported against it.

Due to the inclination of the pivot axis, a gravitational caused restoring force is produced when the door member is pivoted open, as the migrating center of gravity of the door member causes an increasing torque about the inclined pivot axis. Thereby, the door member is pivoting back into the closed position even if an adult has forgotten to close or has no free hand for closing.

Additionally, the safety gate, in particular for children, can include a frame and a door member, the door member being articulated at the frame pivotably about a pivot axis, whereby the pivot axis has an inclination with respect to a vertical, and wherein the pivot axis in particular can extend in a plane with the frame and the closed door member.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a plan view of an inventive safety gate with a slightly opened door member.

FIG. 2 shows a perspective view of the safety gate of FIG. 1.

FIG. 3 shows a detailed view of a closure member with a countersupport of the safety gate of FIG. 1.

FIG. 4 shows four different views of the closure member of FIG. 3.

FIG. 5 shows several sectional views of the closure member of FIG. 4.

FIG. 6 shows several separate parts of the closure member of FIG. 4.

FIG. 7 shows the countersupport of FIG. 3 in a plan view from the side and with two sectional views.

FIG. 8 shows an upper swivel of the door member in a side view and two sectional views.

FIG. 9 shows a further locking of the safety gate of FIG. 1 in a perspective view.

FIG. 10 shows a perspective total view of a further embodiment of an inventive safety gate, as well as an enlarged view of the area A.

FIG. 11 shows an exploded perspective view of a swivel of the safety gate of FIG. 10.

FIG. 12 shows several plan views and a sectional view through the line A-A of the swivel of FIG. 11.

### DETAILED DESCRIPTION

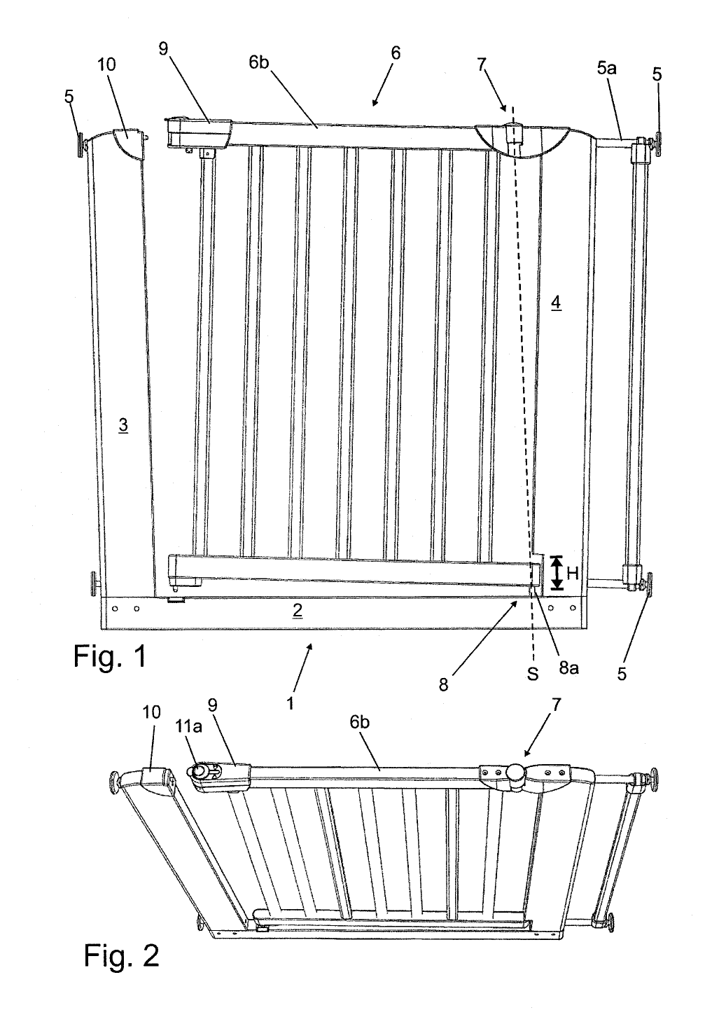

The safety gate shown in FIG. 1 comprises a frame 1 which essentially includes a lower base 2, a first, vertical side part 3 and a second, vertical side part 4. The frame 1 is stationarily positionable, for example in a door frame, by means of respectively two clamping screws 5 which are arranged at each of the side parts 3, 4. The clamping screws may, in a known manner, reach into sockets screwed to the door frame (not shown). The clamping screws arranged at the side part 4 are provided with an optional extension 5a for fixation a overbroad door frames, wherein a vertical stabilizing rod 5b is provided between the extensions 5a.

A door member 6 is pivotably received in the frame 1. This is achieved by an upper swivel 7 and a lower swivel 8. The upper swivel 7 is formed as a plastic cast part and is fixedly connected to an upper end of the second side part 4 on one side and to an upper crossbar of the door member 6 on the other side. The lower swivel 8 comprises a pin 8a which is received in the base 2 of the frame 1 and extends into a borehole in a lower crossbar of the door member 6.

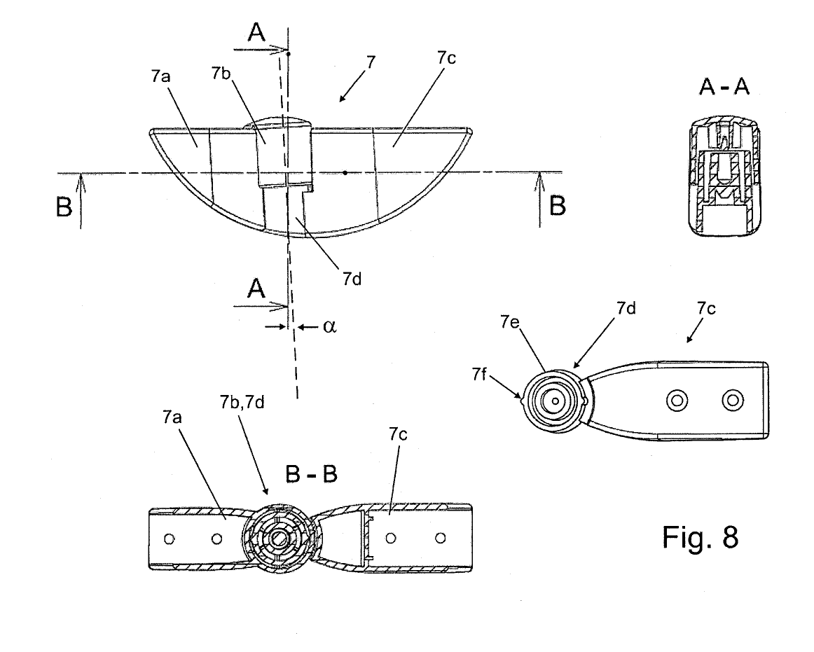

A pivot axis S of the door member 6, which is defined as a connecting line of the two swivels 7, 8, has—provided a vertical positioning of the frame 1—an inclination of an angle α, wherein the pivot axis extends in the plane of the frame 1 and the closed door member 6. The angle α has a size of about 3° in the present example (see also FIG. 8, where the section line extends vertically). Caused by this inclination by the angle α, the center of gravitation of the door member migrates upwards during an opening, such that an increasing torque is generated in a respective closing direction. In FIG. 1, the inclination of the slightly opened door is visible. As an additional remark, FIG. 2 shows the safety gate in a state not yet adjusted with respect to the clamping screws 5, in this case being the reason for the gap between side part 3 and door member 6.

The upper swivel 7, see the detailed view in FIG. 8, has a door-sided hinge half 7a with a first swivel half 7b and a frame-sided hinge half 7c with a second swivel half 7d. The swivel halves 7b, 7d are plugged into each other, wherein the swivel halves can be mutually shifted about a stroke H in the direction of the pivot axis S (swivel axis). In the region of a cylindrical wall 7e, the one swivel half 7d has two radially protruding and axially continuously extended cams 7f, the cams 7f being supported as a support against a corresponding wall of the other swivel half 7b. The two cams 7f are arranged in a plane of the closed door member. In summary, the friction area is reduced and a jamming in the course of an axial mutual movement of the swivel halves 7b, 7d is prevented. The swivel halves 7a, 7c are inclinedly arranged by the angle α, whereas the upper sides of portions of the swivel 7, which portions are to the connected to the door member 6 and side part 4, extend horizontally, as in particular shown in FIG. 8. The lower swivel 8 is designed such that the lower crossbar 6a of the door member 6 protrudes into a recess 4a of the swivel-sided side part 4. Thereby a maximum stroke H of the door member in the course of a movement in the direction of the pivot axis S is defined, wherein the crossbar 6a, at the maximum of the stroke H, abuts at an upper edge of the recess 4a.

For the purpose of a releasable fixing of the door member 6 at the frame 1 in a closed or pivoted shut position, a closure member 9 and a countersupport are provided. The closure member 9 is presently arranged at one end of an upper crossbar 6b of the door member 6, and the countersupport 10 is arranged at the opposing side part 3.

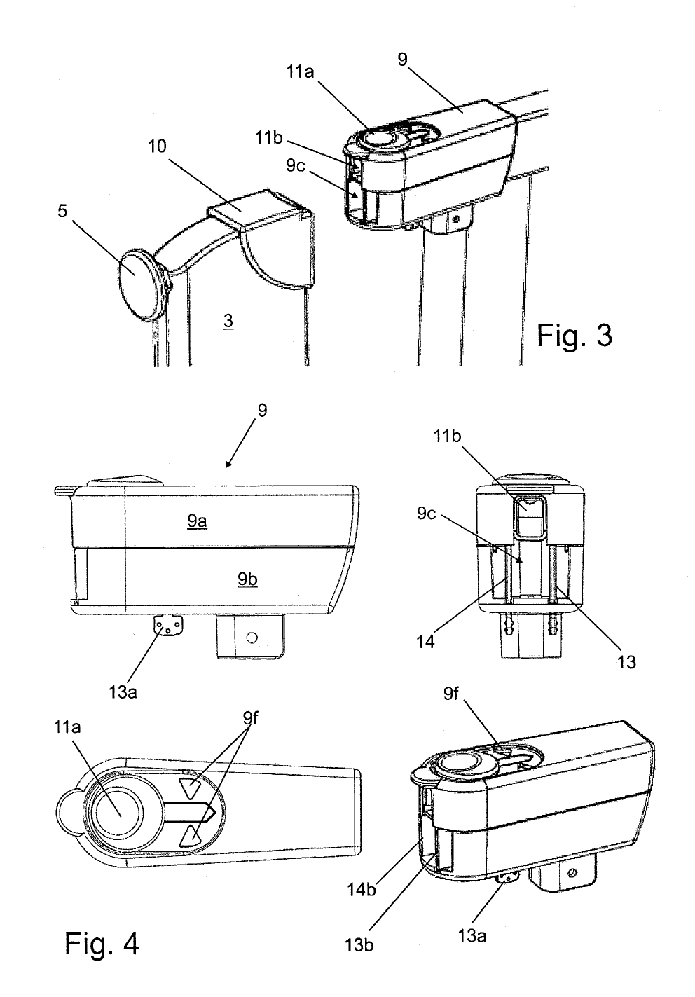

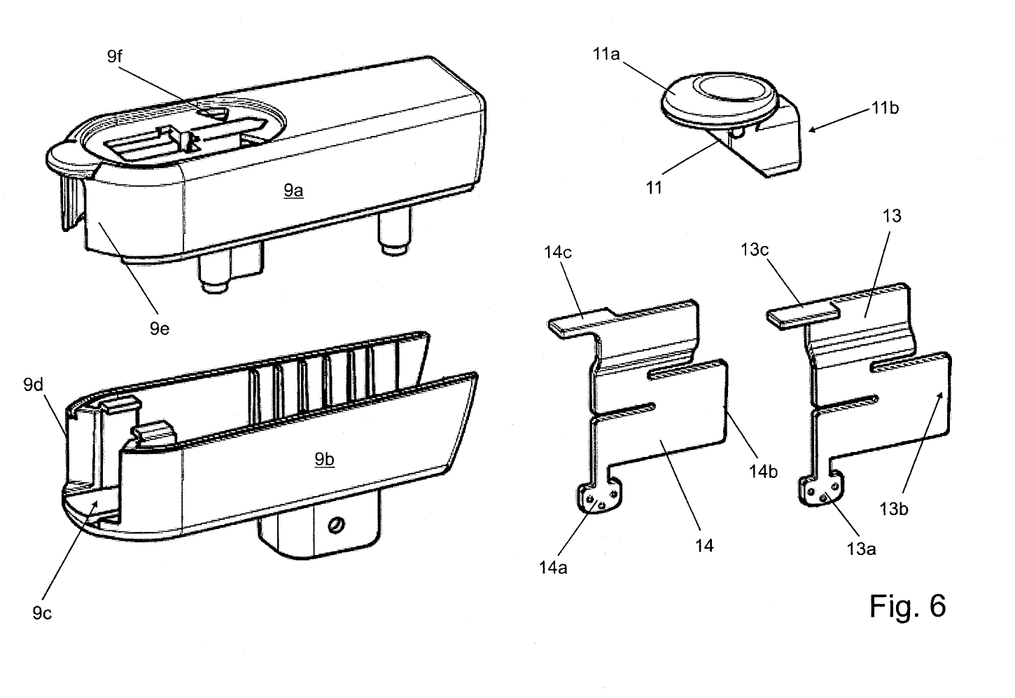

The closure member 9 is largely formed as a cast plastic part and comprises an upper housing part 9a, a lower housing part 9b, a linearly movable latch 11 with an actuation knob 11a an a front opening 11b, a spring 12 acting upon the latch 11 and two blocking bars 13, 14 (see in particular FIG. 3 to FIG. 6), the function of which being described further below. The mutually mounted housing parts 9a, 9b are connected to an end of the upper crossbar in a clamping and/or positive manner. The latch 11 and the blocking bars 13, 14 are movably received between the housing parts.

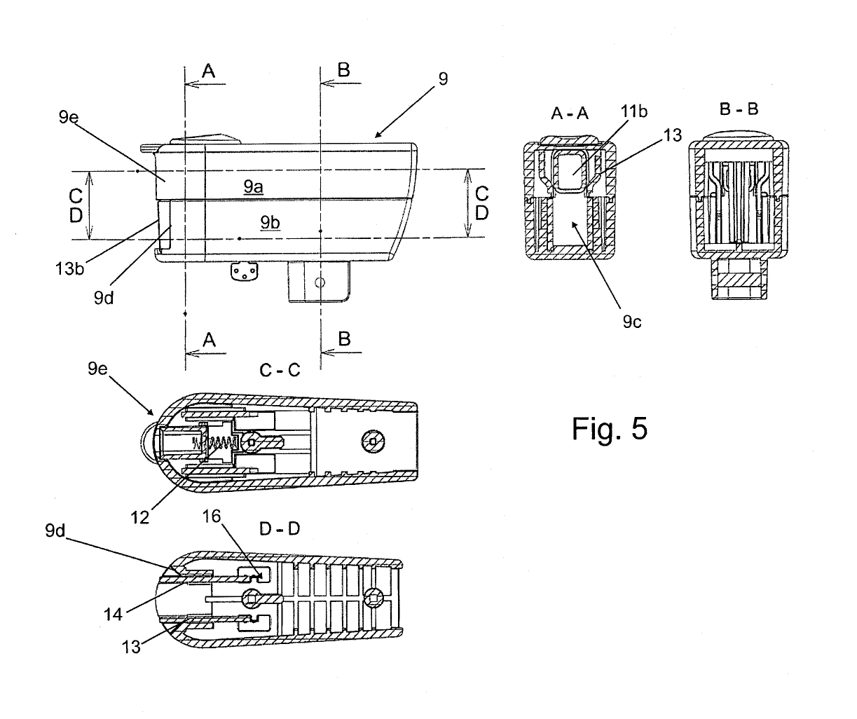

Particularly from FIG. 5 it can be noticed that the latch 11 is positioned in the upper housing part 9a, wherein in the lower housing part 9b, below the latch 11, an opening region 9c is provided, side flanks 9d of the opening region being set back.

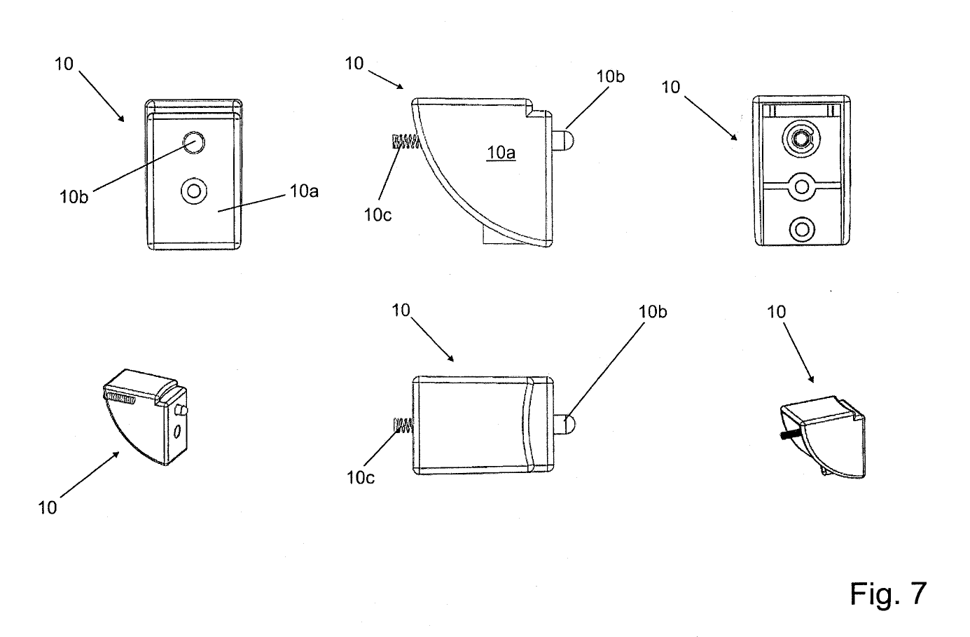

The countersupport 10 (see FIG. 7) comprises a housing part 10a which is pushed onto the upper, door-sided corner of the first side part 3 and bolted. A pin 10b particularly made from metal is received in the housing part in a linearly movable manner, which pin is loaded by a spring 10c. The pin 10a provides a spring-loaded catch which, in a closed state of the door member, extends into the opening 11b of the latch 11 of the closure member 9.

The function of the closure member is as follows:

In the closed state, the catch 10a extends into the opening 11b of the latch 11, such that the door member is blocked with respect to a lifting as well as a pivoting about the pivot axis S. By actuating the actuation knob 11a, the latch 11 can now be shifted back against the spring, such that a lifting of the door member about the described stroke H becomes possible. In this case, at first a pivoting is blocked by the front end flanks 9e of the upper housing part 9a, such that a pivot-blockade is established by the closure member even after release of the locking member which is provided by the latch 11 and the catch 10b.

After a lifting of the door member about the free stroke H, which is defined by the swivel 8, the pin or catch 10a is positioned on the same height with the set-back side flanks 9d of the lower housing half, thereby a pivoting of the door member being released with respect to the catch 10a. in principle, the door can now be pivoted open into both directions.

In the present embodiment, furthermore a blocking member is provided which is integrated in the closure member, and which blocking member comprises the two blocking bars 13, 14. The blocking bars have, in each case, an actuation tab 13a, 14a which protrudes from below the housing part 9b through openings, each of the blocking bars 13, 14 being movable independently from each other into a blocking front position or into a releasing backwards position by means of the actuation tabs. In these positions, the actuation tabs 13a, 14a respectively engage into notches 16 which are formed in the openings of the lower housing part 9b. In the blocking position, a front tab 13b, 14b of the blocking bars respectively protrudes over the flanks 9c of the lower housing half 9b, such that the catch 10b can be blocked by each of the blocking bars in respectively one pivoting direction of the door member.

Hence, by the shifting of one or both of the blocking bars 13, 14, an opening of the door can be selectively blocked in one of the two directions of completely in both directions. Thereby, an additional safety against an actuation by a small child can be achieved and the opening function of the door member can be adjusted to the respective installation situation of the safety gate. This may, for instance, be demanded in the case of positioning at a staircase, in which case a pivoting into a given direction shall generally be impossible.

The adjustment of the blocking member 13, 14 can simply and clearly be seen by means of an additional display, the display comprising one indicator window 9f for each of the blocking bars 13, 14, wherein the indicator window is formed as an opening in the upper side of the upper housing half 9a. Further, the blocking bars 13, 14 have a respective indicator face 13c, 14c overlapping with the windows 9f, which faces may have a color marking, for instance. According to the detailed embodiment, it for example be provided that in the case of forwardly moved blocking member 13, 14 a red mark is visible in its corresponding indicator window, and a green mark in the case of a backwards moved or open blocking member 13, 14.

When pivoting the door member closed, which in particular may happen automatically, presently caused by gravitation, the catch 10b slides alongside the curved outer faces of the flanks 9e of the upper housing part 9a and is thereby pushed back against the spring load. When the catch 10b comes to overlap with the opening 11b of the latch 11, it snaps into the opening and the door is closed. It is to be understood that the latch 11 is generally in its closed position because of the spring 12, provided an operator is not acting upon the actuation knob 11a into the opening direction of the latch 11.

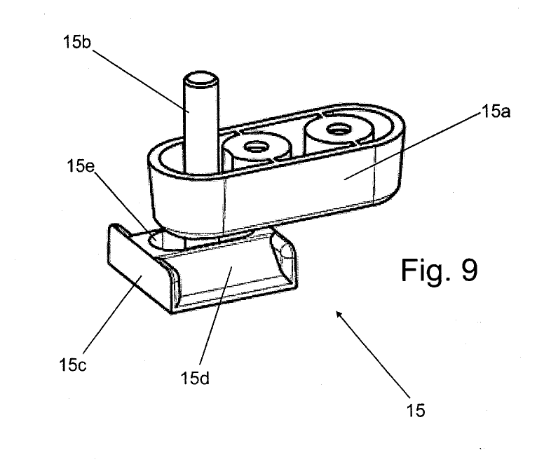

Apart from the above described closure member 9, the safety gate has a further locking 15, which is placed spaced apart from the closure member 9 at a lower crossbar 6a of the door member 6. FIG. 9 displays this locking in a closed state. An upper locking half 15a is bolted to the lower crossbar 6a of the door member 6 and comprises a locking pin 15b extending vertically downwards, the locking pin being movably shiftable in its longitudinal direction in the way of a catch and is loaded in downwards direction by means of a not displayed spring.

In the closed state of the door, the locking pin 15b protrudes into a recess 15e of a countersupport 15c which is bolted to the base 2 of the frame 1. The side walls 15d of the countersupport are beveled towards the outside, such that, in the course of pivoting the door closed, the spring loaded catch 15b slides over the beveled side walls and is compressed inwards, then snapping into the recess 15e.

For opening of the door member 6, the further locking 15 is brought out of meshing by lifting of the door member 6 about the above mentioned stroke H.

In the present embodiment, the locking 15, which is additionally provided and spaced apart from the closure member 9, provides an accompanying measure, which also stabilizes the door, wherein the principal locking function is already integrated in the closure member 9. In the case of other embodiments of the invention, the locking 15 may be omitted according to the demands, or even the blockade of the door member against pivoting may exclusively be provided by the further locking.

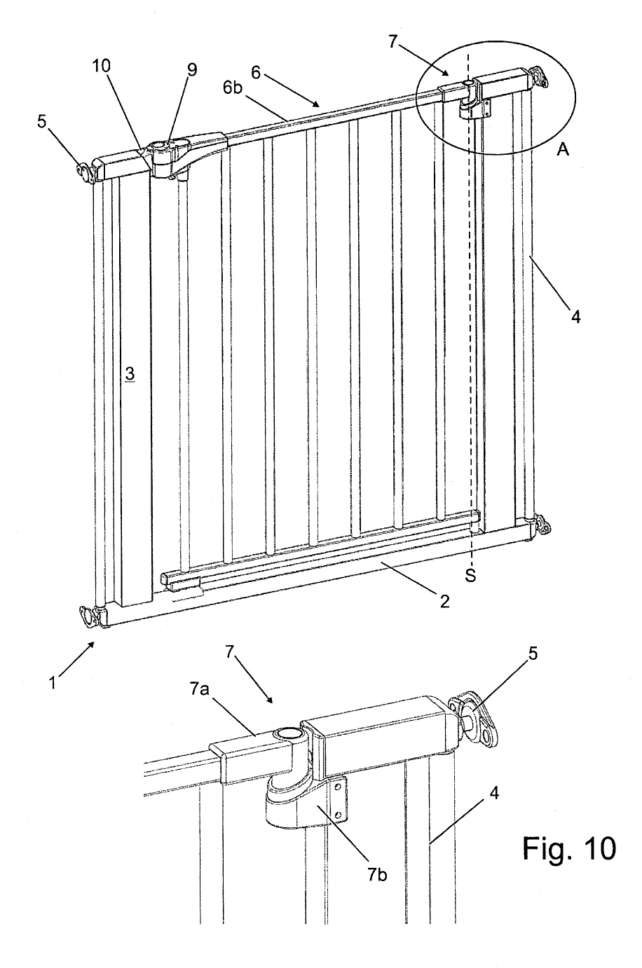

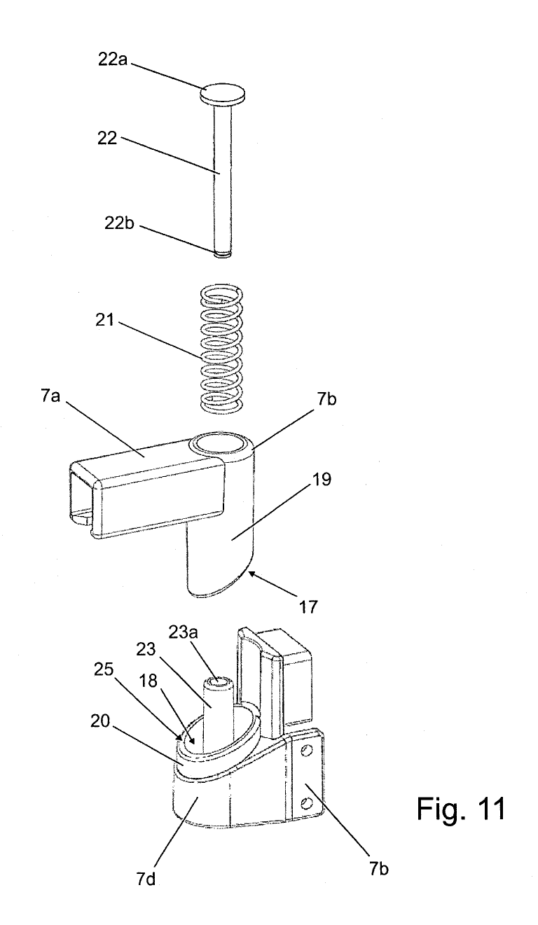

FIG. 10 to FIG. 12 show a further embodiment of the invention, wherein, like in the above embodiments, the door member receives a restoring force into the closing direction if elongated from its closed position. But differently than in the example of FIG. 1, this is not achieved by an inclination of the pivot axis S, but by a restoring torque generated in the upper swivel.

In this respect, the swivel 7 again has an upper, door-sided hinge half 7a with a first swivel half 7b, as well as a frame-sided hinge half 7c with a second swivel half 7d.

Each of the swivel halfs 7b, 7d has a sliding track 17, 18, wherein the sliding tracks 17, 18 are supported against each other. The sliding track of the first swivel half 7b is designed as a front side rim area 17 of a hollow cylindrical section 19. The rim area 17 relates to the section area of the hollow cylinder with a plane which is approximately inclined by 25°, such that the rim area or sliding track 17 is inclined about this angle with respect to the pivot axis or axis of rotation S of the swivel 7.

The wall thickness of the hollow cylindrical section can be less than a quarter, in the present case only almost a sixth, of its diameter. The diameter is about 17 mm and the wall thickness is about 3 mm.

The hollow cylindrical section 19 of the first swivel half is covered by a sleeve part 20 of the second swivel half in every state of opening, starting from the first swivel half's sliding track 17 over its entire height difference. The sleeve part 20, which is also formed as a hollow cylinder, protrudes up from a bottom area which is also inclined by about 25°, a sliding track 18 of the second swivel half being formed by the bottom area. The upper rim of the sleeve part 20 is inclined by this angle as well, although this is not adding to the restoring force, but has mainly design purposes and helps in decreasing the height of the construction of the swivel.

A tenon 23, which is formed from the same material and as one piece, is protruding upwards from the center of the bottom region and into the hollow cylindrical section 19 of the first swivel half. A center through-hole 23a of the tenon 23 has the purpose of putting a metal anchorage 22 through. The anchorage reaches through the tenon 23 or the second swivel half 7d and is secured from the underside by means of a snap ring 24 put onto a groove 22b and is supported against the second swivel half 7d.

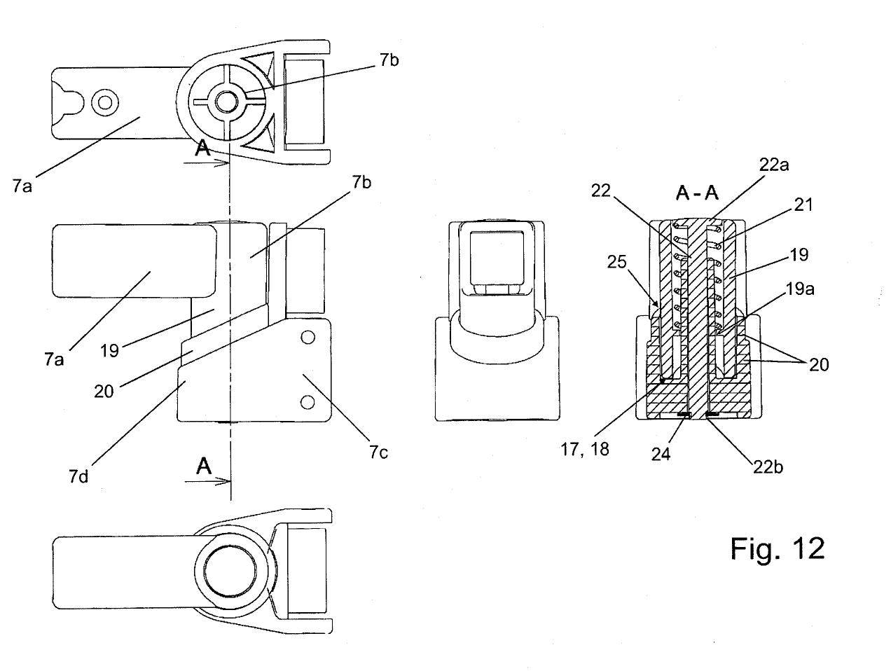

A spring member in the form of a coil spring 21 is reached through by the anchorage 22 and, at its one end, is supported against a head of the anchorage 22, and, with its other end, is supported against a stop 19a in the hollow cylindrical section 19 of the first swivel half 7b. In particular the sectional view of FIG. 12 along the line A-A shows that the spring 21 is furthermore reached through about a part of its length by the tenon 23.

The radial mutual supporting of the swivel halves 7b, 7d is essentially achieved by the contact of the outer wall of the hollow cylindrical section 19 with the inner wall of the sleeve part 20. According to the respective form of the sleeve part 20, at least in the case of a low radial load, the contact may happen predominantly at an inwardly pulled rim area 25, such that the friction areas are reduced and the swivel is particularly smooth in the case of low radial force.

Both hinge halves 7a, 7c and/or swivel halves 7b, 7d can be formed as plastic parts, e.g. injection-cast parts. This enables a cost effective production, wherein the plastic parts sufficiently ensure the function of the self-closing swivel because of the present design.

In particular, the radial supporting is completely carried by the swivel halves 7b, 7d, such that the metal anchorage 22 can be outlayed in a way that it support just axial tractive forces.

The lower swivel 8 of the door member 6, like in the first embodiment, is formed as a simple pivot which is received in a borehole of the bottom base. Because in the example of FIG. 10 the anchorage 22 is limiting the stroke H in the swivel 7, a stop in the region of the lower swivel 8 like in FIG. 1 is not necessary.

The swivel 7 according to the second embodiment functions as follows:

In the closed position (see e.g. FIG. 10 and FIG. 12), the two sliding tracks 17, 18 are put against each other entirely over their circumference. When opening the door member 6, this is lifted by the stroke H like in the first embodiment, which stroke can maximally happen until the spring 21 is fully compressed.

When pivoting the door member 6 open, the bottom end of the first sliding track 17 runs on the lower, second sliding track 18 upwards, according to the given inclination, such that the first, upper swivel half 7b is set upwards with respect to the second, lower swivel half 7d. Thereby, the spring 21 is compressed and stores elastic energy. A further force, which has the same direction than the spring force, is caused on the sliding tracks 17, 18 by the weight force of the door member 6.

Accordingly, a restoring force or torque is acting in the respective closing direction of the door member 6.

It is to be understood that a combination of the embodiments of FIG. 1 and FIG. 9 with respect to the restoring force is possible according to the demands, say for instance the combination of the swivel from FIG. 9 with the inclined pivot axis S from FIG. 1.

Generally it is pointed out that the expression “safety gate” in the sense of the invention not just comprises door members with grid-like structures, as they are part of the door member of the present embodiment with its crossbars 6a, 6b and longitudinal bars, but also solid faces, for instance made from wood, plastics or plexiglass.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. Safety gate for children, the safety gate comprising:
a stationarily positionable frame having a lower base and two side parts, the two side parts extending upwards from the base;
a door member configured to be articulated at the frame pivotably about a pivot axis;
a closure member arranged at the frame or the door member;
a countersupport arranged at the frame or the door member such that the closure member and the countersupport interact with one another in a closed position of the door member; and
an adjustable blocking member arranged at the door member,
wherein the door member is movable in a direction of the pivot axis to release a positive blockade, and
wherein one of the pivot directions of the door member, starting from the closed position, is configured to be releasably blocked via the blocking member.

2. The safety gate of claim 1, wherein the movability of the door member in the direction of the pivot axis is releasably locked via an actuable locking member.

3. The safety gate of claim 1, wherein the locking member is arranged at the closure member, and wherein the locking member has a spring loaded latch that is movable in a linear direction.

4. The safety gate of claim 1, wherein a spring loaded catch is arranged at the closure member or the countersupport, the spring loaded catch being configured to snap into a latch of the locking member when the door member is pivoted into the closed position.

5. The safety gate of claim 1, wherein the blocking member is arranged at the closure member.

6. The safety gate of claim 1, wherein, no pivot direction, one of the two pivot directions, or both pivot directions are selectably blocked by the blocking member, and wherein the blocking member has two displaceable blocking bars.

7. The safety gate of claim 1, wherein the blocking member has a display for a visual control of a selected blocking function.

8. The safety gate of claim 1, wherein a further locking is arranged at the door member for providing or supporting a positive blockade.

9. The safety gate of claim 8, wherein the further locking gets out of engagement by the movement of the door member in the direction of the pivot axis.

10. The safety gate of claim 8, wherein the further locking snaps shut by pivoting of the door member into a closed position.

11. The safety gate of claim 1, wherein the pivot axis is inclined with respect to a vertical, and wherein the pivot axis extends in a plane with the frame and the closed door member.

12. The safety gate of claim 11, wherein the inclination angle is between 1° and 5° or between 2° and 4°.

13. The safety gate of claim 1, wherein a swivel of the door member comprises an upper swivel half and a lower swivel half that are rotatable with respect to each other about the pivot axis, wherein the swivel halves are supported against each other via a sliding track that is progressingly inclined with respect to the pivot axis such that the swivel halves are continuously moving away from each other in the direction of the pivot axis with an increasing opening angle of the door member during a deflection of a spring member, and wherein a force, which is directed opposite to this movement, causes a torque in a closing direction of the door member.

14. The safety gate of claim 13, wherein the sliding track is formed at a first of the two swivel halves as a front side rim area of a hollow cylindrical section, wherein the hollow cylindrical section, starting from a rim area, is covered by a sleeve part of the other, second swivel half.

15. The safety gate of claim 13, wherein a sliding track of the second swivel half is formed as a bottom area of the sleeve part and interacts with the sliding track of the first swivel half, and wherein a tenon is formed as one piece protruding from the bottom plane, the tenon being penetrated by an anchorage, which is made from metal.

16. A safety gate for children, the safety gate comprising:
a stationarily positionable frame having a lower base and two side parts, the two side parts extending upwards from the base;
a door member being articulated at the frame pivotably about a pivot axis;
a closure member arranged at the frame or the door member;
a countersupport arranged at the frame or the door member, such that the closure member and the countersupport interact in a closed position of the door member; and
a spring loaded catch arranged at the closure member or the countersupport, the spring loaded catch configured to snap into a latch of the locking member when the door member is pivoted into the closed position,
wherein the door member is moveable in the direction of the pivot axis in order to release a positive blockade, and
wherein a movability of the door member in the direction of the pivot axis is releasably locked via an actuable locking member.

17. A safety gate for children, the safety gate comprising:
a frame; and
a door member, the door member being articulated at the frame pivotably about a pivot axis,
wherein the pivot axis has an inclination with respect to a vertical, and
wherein the pivot axis extends in a plane with the frame and the closed door member.
